(19) United States
(12) Patent Application Publication
(10) Pub. No.: US 2018/0312124 A1
(43) Pub. Date: Nov. 1, 2018

(54) Control System and Method

(71) Applicant: Alexander Dennis Limited, Falkirk (GB)

(72) Inventors: Daniel Hyden, Falkirk (GB); Jonathan Wilson, Falkirk (GB); Kevin Scott, Falkirk (GB)

(73) Assignee: Alexander Dennis Limited, Falkirk (GB)

(21) Appl. No.: 15/769,274

(22) PCT Filed: Oct. 18, 2016
(86) PCT No.: PCT/GB2016/053238

§ 371 Date: Apr. 18, 2018

(30) Foreign Application Priority Data
Oct. 18, 2015 (GB) 1518408.8

(51) Int. Cl. B60R 16/03; H02J 7/14

(52) U.S. Cl. CPC B60R 16/03; H02J 7/1423; B60L 1/00; B60L 2200/18; B60L 2240/54

(57) ABSTRACT

A controller or processing system for a vehicle, such as a passenger service vehicle, the vehicle having at least one energy storage system, at least one alternator or other charging device coupled to and/or operable or driven by an engine or motor, wherein the alternator or other charging device is switchable between an operational state and a non-operational state by the controller or processing system responsive to one or more parameters of the vehicle. The invention also includes an associated vehicle and method. The parameters of the vehicle optionally include one or more or each of: acceleration of the vehicle, accelerator pedal position, vehicle speed, rotation speed of the engine, the gear currently selected and/or the current being drawn from, or load on, the at least one energy storage system and/or current being drawn by one or more or all electrical components of the vehicle and/or engine coolant temperature.

### FIELD OF INVENTION

The invention relates to a control system and method for an alternator or other charging device of a vehicle. The invention also relates to an associated vehicle and method. In particular, the invention relates to, but is not limited to, a control system and method for passenger service vehicles.

### BACKGROUND

As used herein, the term “passenger service vehicle” encompasses vehicles for transporting passengers and, in particular, road vehicles for transporting passengers. Exemplary passenger service vehicles may be buses, coaches or the like.

Significant innovation and technology development has occurred in recent years in relation to the design of passenger service vehicles. In particular, there has been a continued drive towards providing vehicles that allow for improved safety, fuel efficiency and ease of maintenance.

### SUMMARY

Various aspects of the present invention are defined in the independent claims. Some preferred features are defined in the dependent claims.

According a first aspect there is provided a controller or processing system for a vehicle, such as a passenger service vehicle, e.g. a bus, coach, minibus or the like. The vehicle may comprise at least one energy storage system, which may comprise one or more batteries. The vehicle may comprise at least one alternator or other charging device. The vehicle may comprise an engine or motor, which may be or comprise an internal combustion engine. The vehicle may optionally but not essentially be a non-electric and/or non-hybrid vehicle, i.e. the vehicle may optionally be propelled by the internal combustion engine alone. The alternator or other charging device may be coupled to and/or operable or driven by the engine or motor. The controller or processing system may be for operating, or configured to control operation of, the alternator or other charging device. The alternator or other charging device may be switchable between a first state, which may be an operational state, and a second state, which may be a non-operational or reduced operation state. In the first (e.g. operational) state, the alternator or other charging device may be configured to provide electrical charge, e.g. to the at least one energy storage system, when operated or driven by the engine or motor. In the second (e.g. non-operational or reduced operation) state, the alternator or other charging device may be configured to provide less or preferably no electrical charge, e.g. to the at least one energy storage system, which may be the case even when the engine or motor is operating. The controller or processing system may be configured to control or selectively vary the load on the alternator or other charging device and/or control or selectively vary the burden or load on the engine or motor due to the alternator or other charging device. The controller or processing system may be configured to switch the alternator or other charging device between the first (e.g. operational) state and the second (e.g. non-operational or reduced operation) state, e.g. responsive to one or more parameters of the vehicle.

The controller or processing system may be configured to implement criteria or logic, specifying when to switch the alternator or other charging device from the first (e.g. operational) state to the second (e.g. non-operational or reduced operation) state and/or when to switch the alternator or other charging device from the second (e.g. non-operational or reduced operation) state to the first (e.g. operational) state. The criteria or logic may specify switching the alternator or other charging device from the first (e.g. operational) state to the second (e.g. non-operational or reduced operation) state and/or switching the alternator or other charging device from the second (e.g. non-operational or reduced operation) state to the first (e.g. operational) state when one or more ranges, values or criteria of at least one or more or each of the parameters of the vehicle are met.

The one or more parameters of the vehicle may comprise one or more or each of: acceleration or deceleration of the vehicle, accelerator pedal position, vehicle speed, rotation speed of the engine, the gear currently selected and/or the current being drawn from, or load on, the at least one energy storage system and/or current being drawn by one or more or all electrical components of the vehicle and/or engine coolant temperature, e.g. relative to ambient. It will be appreciated that one or more or each of these are parameters may often be routinely measured and monitored, e.g. by engine control systems. As such, by basing the selective operation of the alternator or other charging device on such parameters, it may be possible to more readily retrofit, adapt or integrate the controller or processing system, e.g. for use with existing vehicles.

The controller or processing system may be configured to switch the alternator or other charging device into the second (e.g. non-operational or reduced operation) state, optionally for a determined or predetermined or variable period of time such as an off-time, when the engine or motor is fuelling and/or providing traction or motive power to the vehicle or the vehicle is accelerating, maintaining speed and/or not coasting. The controller or processing system may be configured to switch the alternator or other charging device into the first (e.g. operational) state when the vehicle is coasting, decelerating and/or the engine or motor is not fuelling and/or not providing traction or motive power to the vehicle. The controller or processor may be configured to prioritize operation of the alternator or other charging device and/or charging of the at least one energy storage system when the vehicle is coasting, decelerating and/or the engine is not fuelling and/or not providing traction or motive power to the vehicle.

The controller or processor may be configured to measure the time that the alternator or other charging device is in the second (e.g. non-operational or reduced operation) state. The controller or processor may be configured to measure the time that the alternator or other charging device is in the first (e.g. operational) state. The controller or processor may be configured to determine a ratio of the time that the alternator or other charging device is in the first (e.g. operational) state to the time that the alternator or other charging device is in the second (e.g. non-operational or reduced operation) state.

The controller or processing system may be configured to control and/or vary the period of time (e.g. the determined or variable period of time) that the alternator or other charging device is in the first and/or second state, e.g. based on the determined ratio and/or a target ratio.

The controller or processing system may be configured to control and/or vary the period of time that the alternator or other charging device is in the first and/or second state to achieve the target ratio. The target ratio may be a target ratio of the time that the alternator or other charging device is in the first (e.g. operational) state to the time the alternator or other charging device is in the second (e.g. non-operational or reduced operation) state.

For example, the controller may be configured to control and/or vary the period of time that the alternator or other charging device is in the first (e.g. operational) state and/or the time that the alternator or other charging device is in the second (e.g. non-operational or reduced operation) state depending on a difference between the determined ratio and the target ratio, e.g. to achieve the target ratio.

The target ratio may be variable. The target ratio may depend on a current provided from the at least one energy storage system (e.g. during discharge and/or when the alternator or other charging device is off, non-operational or de-excited). The controller or processing system may be provided with or configured to access predetermined correspondence data, such as a look-up table or algorithm, that associates values of the target ratio to corresponding values or ranges of current provided from the at least one energy storage system (e.g. during discharge). In this way, the measured current provided from the at least one energy storage system (e.g. during discharge) may be cross referenced against the correspondence data in order to determine the applicable target ratio.

By selectively prioritizing use of the alternator or other charging device in periods where the vehicle is coasting, decelerating and/or the engine is not fuelling and/or not providing traction or motive power to the vehicle, the additional fuel required by the engine in order to operate or drive the alternator or other charging device may be reduced, which may thereby reduce the fuel consumption of the vehicle.

The controller or processing system may be configured to determine if the accelerator pedal is depressed by more or less than an accelerator threshold amount or range. The controller may be configured to at least partially determine whether or not to switch the alternator or other charging device between the first (e.g. operational) state and the second (e.g. non-operational or reduced operation) state dependent on whether the accelerator pedal has been depressed by more or less than the accelerator threshold amount or range. For example, the controller or processing system may be configured to switch the alternator or other charging device to the operational state based at least partially on the determination that the accelerator pedal is being depressed by less than the accelerator threshold amount or range and/or the accelerator pedal is not being depressed (e.g. the threshold may be zero). The controller or processing system may be configured to switch the alternator or other charging device to the second (e.g. non-operational or reduced operation) state based at least partially on the determination that the accelerator pedal is being depressed by more than the accelerator threshold amount or range. The accelerator threshold amount or range may be non-zero, e.g. between 2% and 20%, such as between 3% and 10% and may be between 5% and 6%.

The controller or processing system may be configured to determine if the vehicle speed is more or less than a speed threshold amount or range. The controller may be configured to at least partially determine whether or not to switch the alternator or other charging device between the first (e.g. operational) state and the second (e.g. non-operational or reduced operation) state dependent on whether the vehicle speed is more or less than the speed threshold amount or range. For example, the controller or processing system may be configured to switch the alternator or other charging device into the first (e.g. operational) state based at least partially on the determination that the vehicle speed is greater than the speed threshold amount or range. The controller or processing system may be configured to switch the alternator or other charging device to the second (e.g. non-operational or reduced operation) state based at least partially on the determination that the vehicle speed is less than the speed threshold amount or range. The speed threshold amount or range may be non-zero, e.g. between 10 and 30 km/h, such as between 12 and 20 km/h.

The present inventors have identified that when the vehicle speed and/or engine speed, e.g. the coasting/idle speed of the vehicle and/or the associated engine speed, drops below a certain amount or range, then the engine draws fuel or increases its fuelling amount, which may be termed “idle fuelling”. As such, by limiting or prioritizing operation of the alternator or other charging device to situations where the vehicle speed and/or engine speed is greater than a threshold amount or range, the fuel consumption of the vehicle may be further reduced.

The controller or processing system may be configured to determine if the engine speed is more or less than an engine speed threshold amount or range. The controller may be configured to at least partially determine whether or not to switch the alternator or other charging device between the first (e.g. operational) state and the second (e.g. non-operational or reduced operation) state dependent on whether the engine speed is more or less than the engine speed threshold amount or range. For example, the controller or processing system may be configured to switch the alternator or other charging device into the first (e.g. operational) state based at least partially on the determination that the engine speed is greater than the engine speed threshold amount or range. The controller or processing system may be configured to switch the alternator or other charging device to the second (e.g. non-operational or reduced operation) state based at least partially on the determination that the engine speed is less than the engine speed threshold amount or range. The engine speed threshold amount or range may be non-zero, e.g. between 400 rpm and 1000 rpm, such as between 600 and 800 rpm.

The controller or processing system may be configured to determine a gear in which a transmission of the vehicle is currently in or is using. The controller may be configured to at least partially determine whether or not to switch the alternator or other charging device between the first (e.g. operational) state and the second (e.g. non-operational) state dependent on which gear the transmission is determined to be in or be using, e.g. whether or not the gear is a forward gear. For example, the controller or processing system may be configured to switch the alternator or other charging device to the second (e.g. non-operational or reduced operation) state based at least partially on the gear being determined to be a forward gear.

The controller or processing system may be configured to switch from the operational state of the alternator or other charging device to the second (e.g. non-operational or reduced operation) state of the alternator or other charging device for the determined or predetermined period of time, e.g. responsive to the one or more parameters of the vehicle. The period of time may be an “off-time”, i.e. a time when the alternator or other charging device is in the non-operational state. The controller or processing system may be configured to determine and/or vary the period of time, e.g. based on a calculated, determined or expected load on the at least one energy storage system and/or a current being drawn from the at least one energy storage system or being drawn by the vehicle's electrical systems and/or based on state of charge or target state of charge of the at least one energy storage system. The state of charge may be an estimated state of charge, e.g. determined without a state of charge battery monitor. The controller or processing system may be configured to measure, or receive a measurement of, the load on the at least one energy storage system and/or the current being drawn from the at least one energy storage system or by the vehicle's electrical systems and/or the determined or target state of charge of the at least one energy storage system. The controller or processing system may be configured to reduce the period of time or off-time with increasing load on the at least one energy storage system and/or the current drawn from the at least one energy storage system or by the vehicle's electrical systems and/or with increasing target state of charge of the at least one energy storage system. For example, the target state of charge may be input manually. The controller or processing system may be configured to increase the period of time or off-time with decreasing load on the at least one energy storage system and/or the current drawn from the at least one energy storage system or by the vehicle's electrical systems and/or with decreasing target state of charge of the at least one energy storage system.

The load on, or the current drawn from, the at least one energy storage system or the vehicle's electrical systems may be measured by a measurement device, e.g. an ammeter or a current clamp, attached to the at least one energy storage system or to a cable from the at least one energy storage system. The load on, or current drawn from, the at least one energy storage system or the vehicle's electrical systems may be a load or current drawn whilst the alternator or other charging device is not active or not charging, e.g. when in the non-operational state. In this way, the load or current may be measured more accurately.

Since the controller or processing system is operable to vary the period of time or off-time based on one or more of the parameters listed above, the state of charge of the battery may be protected and/or the lifetime of the battery may be improved, as the battery may be operated within a preferred state of charge regimen.

The controller or processing system may be configured to vary the charging voltage applied to the at least one energy storage system, e.g. dependent on a state-of-charge of the at least one energy storage system (e.g. a current or present state-of-charge) and/or dependent on an electrical current being supplied to the at least one energy storage system during charging (e.g. when the alternator or other charging device is generating electricity). The controller or processing system may be configured to increase the charging voltage applied to the at least one energy storage system with decreasing state-of-charge and/or with increasing electrical current being supplied to the at least one energy storage system during charging. The controller or processing system may be configured to decrease the charging voltage applied to the at least one energy storage system with increasing state-of-charge and/or with decreasing electrical current being supplied to the at least one energy storage system during charging.

The controller or processing system may be configured to increase the charging voltage applied to the at least one energy storage system or switch the charging voltage to a high charging voltage if the electrical current being supplied to the at least one energy storage system during charging is greater than a threshold (or the state-of-charge of the at least one energy storage system is less than a threshold). The controller or processing system may be configured to decrease the charging voltage applied to the at least one energy storage system or switch the charging voltage to a low charging voltage if the electrical current being supplied to the at least one energy storage system during charging is less than the threshold or another threshold (or the state-of-charge of the at least one energy storage system is greater than a threshold or another threshold) or if a predetermined time has elapsed since the charging voltage was switched to the high charging voltage.

The electrical current being supplied to the at least one energy storage system at a given point in time may be indicative of the state-of-charge of the at least one energy storage system at that time, for example a high or higher charging current may be indicative of low or lower state of charge and a low or lower charging current may be indicative of a high or higher state of charge. A relationship between electrical current being supplied to the at least one energy storage system and the state-of-charge of the at least one energy storage system may be stored or provided, e.g. from manufacturers, calibration, in-use or experimental data.

The controller or processing system may be operable to ensure that the alternator is in the first (e.g. operational) state and/or the at least one energy storage system is charged or continuously charged for at least a predetermined or determined period, e.g. at predetermined or determined intervals. For example, the controller or processing system may be configured to ensure that the alternator is in the first (e.g. operational) state and/or the at least one energy storage system continuously charged for set period every day. The controller or processing system may be configured to determine temperature of an engine coolant, e.g. relative to ambient temperature. The temperature of the coolant may be indicative of the interval at which the alternator is in the first (e.g. operational) state and/or the at least one energy storage system is charged or continuously charged for at least a predetermined or determined period. The controller or processing system may be configured to switch the alternator or other charging device into the first (e.g. operational) state for at least the predetermined or determined period when or if the temperature of the engine coolant is less than a threshold amount or range (e.g. +10° C.) over ambient temperature.

Passenger service vehicles such as busses may be used throughout a working day. In this case, the coolant temperature being less than a threshold amount or range above ambient temperature may be representative of the vehicle being used for the first time in a working day. This may ensure that the at least one energy storage system is charged by at least the predetermined or determined amount once or at least once every working day. However, it will be appreciated that other techniques for determining when to put the alternator into the operational state according to the predetermined or determined interval may be used in addition to or instead of monitoring the coolant temperature. For example, a GPS system or tachometer system or other operational logging system may be used to determine when to put the alternator into the operational state according to the predetermined or determined interval, e.g. when the vehicle has been stationary at a location such as a depot and/or has been stationary for a predetermined period of time. Other options may comprise use of a timer, such as an ignition off timer, or electronic calendar to determine when the at least one energy storage system should be charged or continuously charged for at least the predetermined or determined period every predetermined or determined interval.

The controller or processing system may be configured to check that the vehicle has undergone coasting or coast-down and/or alternator is in the first (e.g. operational) state, or has been switched into the first (e.g. operational) state since the last determination that the alternator should be placed in the second (e.g. non-operational or reduced operation) state, before switching the alternator into the second (e.g. non-operational or reduced operation) state, or vice versa.

The alternator or other charging device may be coupled with or operated by or driven by the engine or motor via a belt or other connection, such as a geared connection, e.g. via a crankshaft, an engine or motor driven pulley and/or the like.

The operational state of the alternator or other charging device may be or comprise an excited or excitable or energized or energizable state. The non-operational state of the alternator or other charging device may be or comprise a de-excited or de-excitable or non-energized or non-energizable state. The controller or processing system may be configured to electrically or electronically switch the alternator between the first (e.g. operational) and second (e.g. non-operational or reduced operation) state. The alternator or other charging device may comprise a coil or wiring in which flow of electrical current is induced during operation of the alternator or other charging device. The controller or processing system may be configured to switch the coil or wiring into a connected state (e.g. electrically connected to a load, such as the at least one energy storage system) in order to switch the alternator or other charging device into the first (e.g. operational) state. The controller or processing system may be configured to switch the coil or wiring into a disconnected or grounded state (e.g. electrically disconnected to the load, such as the at least one energy storage system or electrically grounded) in order to switch the alternator or other charging device into the second (e.g. non-operational or reduced operation) state.

The controller or processing system may comprise a processing unit such as a central processing unit (CPU). The controller or processing system may be or comprise or be comprised in an engine controller or a vehicle system controller. The controller or processing system may comprise or be configured to access a memory and/or data storage. The controller or processing system may comprise or be configured to access a communications system, e.g. for communicating with one or more vehicle parameter sensors, e.g. in order to receive or determine the one or more parameters of the vehicle and/or to communicate with the alternator or other charging device and/or a controller therefor, in order to selectively control the alternator or other charging device.

According to a second aspect of the present invention is an electrical system for a vehicle, such as a passenger service vehicle, the electrical system comprising at least one energy storage system, at least one alternator or other charging device and a controller or processing system according to the first aspect, wherein the alternator or other charging device is switchable between a first (e.g. operational) state and a second (e.g. non-operational or reduced operation) state by the controller or processing system responsive to one or more parameters of the vehicle.

According to a third aspect of the present invention is a vehicle, such as a passenger service vehicle, e.g. a bus, coach, minibus or the like, the vehicle comprising the controller or processing system of the first aspect. The vehicle may comprise at least one energy storage system, which may comprise one or more batteries. The vehicle may comprise at least one alternator or other charging device. The vehicle may comprise an engine or motor, which may be or comprise an internal combustion engine. The vehicle may optionally but not essentially be a non-electric and/or non-hybrid vehicle, i.e. the vehicle may optionally be propelled by the internal combustion engine alone. The alternator or other charging device may be coupled to and/or operable by or driven by the engine or motor. The controller or processing system may be for operating, or configured to control operation of, the alternator or other charging device. The alternator or other charging device may be switchable between a first (e.g. operational) state and a second (e.g. non-operational or reduced operation) state. The controller or processing system may be configured to control or selectively vary the load on the alternator or other charging device and/or control or selectively vary the burden or load on the engine or motor due to the alternator or other charging device. The controller or processing system may be configured to switch between the first (e.g. operational) state of the alternator or other charging device and the second (e.g. non-operational or reduced operation) state of the alternator or other charging device, e.g. responsive to one or more parameters of the vehicle.

The one or more parameters of the vehicle may comprise one or more or each of: acceleration and/or deceleration of the vehicle, accelerator pedal position, vehicle speed, rotation speed of the engine, the gear currently selected and/or the current being drawn from, or load on, the at least one energy storage system and/or current being drawn by one or more or all electrical components of the vehicle and/or engine coolant temperature.

According to a fourth aspect of the present invention is a method of producing a controller or processing system according to the first aspect. The method may comprise providing a controller or processing system, the controller comprising a processing unit, a memory and a communications system. The method may comprise configuring or programming the controller or processing system to control operation of an alternator or other charging device. The method may comprise configuring or programming the controller or processing system to switch the alternator or other charging device between a first (e.g. operational) state and a second (e.g. non-operational or reduced operation) state. The method may comprise configuring or programming the controller or processing system to control or selectively vary the load on the alternator or other charging device and/or control or selectively vary the burden or load on the engine or motor due to the alternator or other charging device. The method may comprise configuring or programming the controller or processing system to switch between the first (e.g. operational) state of the alternator or other charging device and the second (e.g. non-operational of reduced operation) state of the alternator or other charging device, e.g. responsive to one or more parameters of the vehicle.

The one or more parameters of the vehicle may comprise one or more or each of: acceleration and/or deceleration of the vehicle, accelerator pedal position, vehicle speed, rotation speed of the engine, the gear currently selected and/or the current being drawn from, or load on, the at least one energy storage system and/or current being drawn by one or more or all electrical components of the vehicle and/or engine coolant temperature.

According to a fifth aspect of the present invention is a method of controlling an alternator or other charging device. The method may comprise controlling operation of the alternator or other charging device. The method may comprise switching the alternator or other charging device between a first (e.g. operational) state and a second (e.g. non-operational or reduced operation) state. The method may comprise controlling or selectively varying the load on the alternator or other charging device and/or controlling or selectively varying the burden or load on the engine or motor due to the alternator or other charging device. The method may comprise switching between the first (e.g. operational) state of the alternator or other charging device and the second (e.g. non-operational or reduced operation) state of the alternator or other charging device, e.g. responsive to one or more parameters of the vehicle.

The one or more parameters of the vehicle may comprise one or more or each of: acceleration and/or deceleration of the vehicle, accelerator pedal position, vehicle speed, rotation speed of the engine, the gear currently selected and/or the current being drawn from, or load on, the at least one energy storage system and/or current being drawn by one or more or all electrical components of the vehicle and/or engine coolant temperature.

According to a sixth aspect of the invention is a computer program product that when programmed into a suitable controller or processing system configures the controller or processing system to perform the method of the third aspect.

According to a sixth aspect of the invention is a carrier medium, such as a physical or tangible and/or non-transient carrier medium, comprising the computer program product of the fifth aspect. The carrier medium may be a computer readable carrier medium.

It should be understood that the features defined above in accordance with any aspect above or below in relation to any specific embodiment of the invention may be utilised, either individually, separably and/or alone or in combination with any other feature defined above and/or below, in connection with any other aspect or embodiment of the invention. Furthermore, the present invention is intended to cover apparatus configured to perform any feature described herein in relation to a method and/or a method of using, producing, manufacturing, repairing, adjusting, fitting or retrofitting any apparatus feature described herein.

### BRIEF DESCRIPTION OF DRAWINGS

Exemplary embodiments are illustrated with reference to the following drawings, of which:

FIGS. 1 and 2 show examples of passenger service vehicles;

FIG. 3 is a schematic of a controller of the vehicle of FIGS. 1 and 2;

FIG. 4 shows logic used by the controller of FIG. 3 for putting an alternator in an operational or excited state;

FIG. 5 shows variations of an off-time characteristic used by the controller of FIG. 3 with load and target state of charge;

FIG. 6 shows logic used by the controller of FIG. 3 for putting the alternator in a non-operational or de-excited state;

FIG. 7 is a flowchart illustrating a method of putting the alternator in the operational or excited state;

FIG. 8 is a flowchart illustrating a method of putting the alternator in the non-operational or de-excited state; and

FIG. 9 shows alternative logic used by the controller of FIG. 3 for switching the alternator between an operational (on) and reduced operational on/off) state.

### DETAILED DESCRIPTION OF THE DRAWINGS

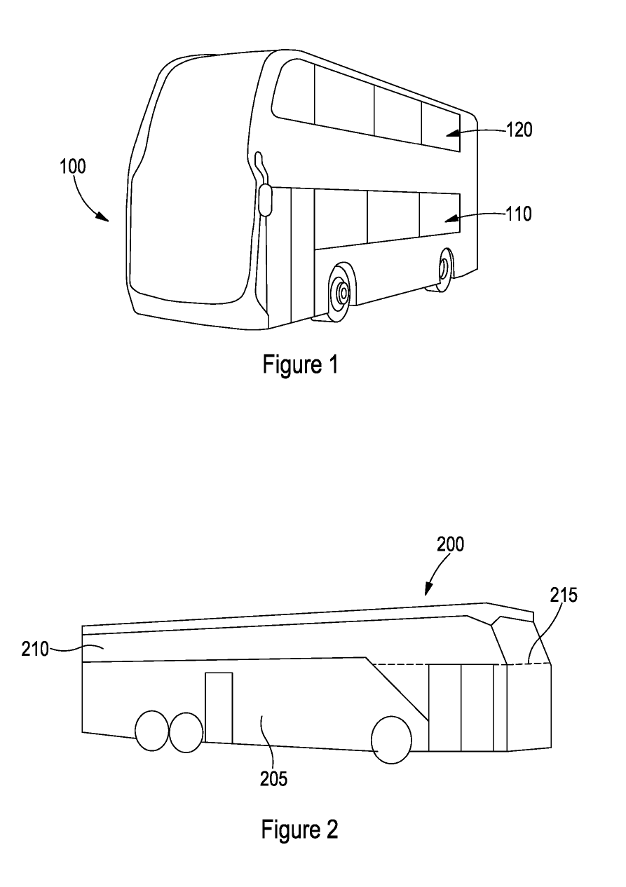

FIG. 1 shows a perspective representation of a passenger service vehicle 100, which, in this example, is shown as a vehicle 100 having both a lower passenger deck 110 (lower deck) and an upper passenger deck 120 (upper deck). Such vehicles 100 are commonly referred to as twin-deck, or double-deck, vehicles 100, and comprise a plurality of passenger seats on each deck.

FIG. 2 shows a perspective representation of an alternative passenger service vehicle 200, having essentially only a single passenger deck 210 (albeit there may be provided a few passenger seats on lower sections of the vehicle also). The vehicle 200 shown in FIG. 2 can be considered to be a coach-type vehicle, in which the passenger deck 210 may be elevated above a luggage locker area 205, or the like. In some examples of such vehicles, the passenger deck 210 may extend for substantially the length of the vehicle 200, and so above a driver's cab (as shown by the dashed lines 215). Other single deck vehicles 200 are also known.

The examples of passenger service vehicles 100, 200 shown in FIGS. 1 and 2 are conventional vehicles in which traction is provided by an internal combustion engine. However, it will also be appreciated that the vehicles 100, 200 may alternately be hybrid electric or electric powered vehicles and may use batteries, fuel cells or any other suitable energy storage mechanism known in the art.

Modern passenger service vehicles often have an array of electrically powered devices such as, but not limited to, vehicle system controllers, air conditioning units, heaters, wi-fi modules, location position and tracking modules such as GPS units, display screens and televisions, music systems, public address systems and the like. As such, there may be significant demand for electrical energy in operation.

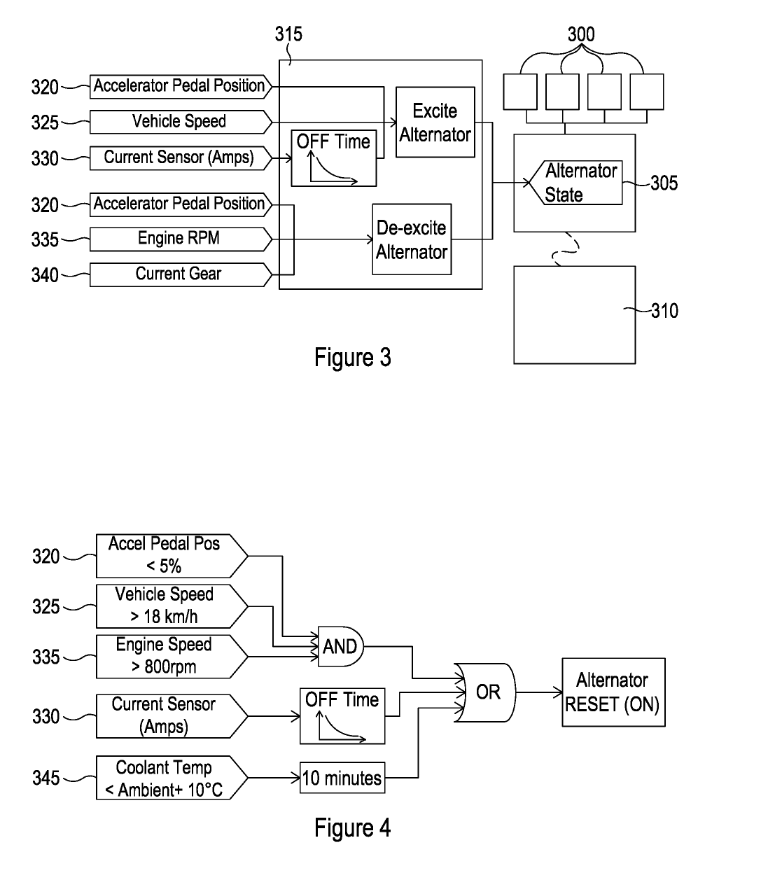

Part of an electrical system of the vehicles 100, 200 is shown in FIG. 3. The passenger service vehicles 100, 200 comprise energy storage systems, typically in the form of one or more battery packs 300. The battery packs 300 are kept charged by one or more recharge devices, typically alternators 305. The alternator 305 is coupled to, and driven by, an engine 310 of the vehicle. For example, the alternator may be driven by a drive belt that is provided around a pulley that is turned by rotation of the engine to thereby turn the drive belt and drive the alternator 305. Alternatively, the alternator 305 can be coupled to the engine 310 by other coupling mechanisms such as gearing arrangements, which may be coupled directly to the engine but are more commonly coupled to a drive shaft, crank shaft or auxiliary shaft that is rotated by or as part of the engine 310.

The alternator 305 is controlled by a controller 315. In particular, the controller 315 is configured to selectively switch the alternator 305 between an operating or energized state and a non-operating or de-energized state.

In the operational or excited state, the alternator 305 is in a configuration in which it generates electricity, e.g. for charging the battery packs 300, responsive to the operation of the engine 310. In the non-operational or de-excited state, the alternator 305 is in a configuration in which it is prevented from either generating electricity or supplying electricity to the battery packs 300, regardless of the operation of the engine 310.

For example, in an embodiment, the alternator 305 comprises one or more coiled windings, at least one rotor and at least one stator. The at least one rotor is rotatable responsive to operation of the engine, which results in a current being induced in the one or more coiled windings. An electrical or electronic switching arrangement is provided that can selectively switch an output of the one or more coiled windings between the battery packs 300 and/or other electrical systems of the vehicle and earth. The alternator 305 can then be returned to the operating state by simply de-earthing and/or reconnecting the coil windings to the output of the alternator 305. In the embodiment, the alternator 305 is switched into the non-operational or de-excited state by earthing the one or more coiled windings using the switching arrangement in order to de-excite or de-energise the one or more coiled windings. It will be appreciated that this significantly reduces the physical load or burden placed on the engine 310 by the alternator 305 in use. This arrangement may provide a fast and convenient electrical or electronic switching mechanism that may be readily retrofitted to existing vehicles.

However, it will be appreciated that other arrangements for placing the alternator 305 into the non-operational or de-excited state could be used. For example, it may be possible to physically couple and de-couple the rotor of the alternator from the engine 310. It will be appreciated that alternator 305 must simply place less of a burden or load on the engine 310 when in the non-operational or de-excited state than when in the operational or excited state in at least one or more or each equivalent operational state of the engine.

The controller 315 is in communication with various vehicle sensors for measuring a plurality of vehicle parameters, such as an accelerator pedal position sensor 320, a vehicle speed sensor 325, a load sensor 330 for measuring total current being drawn from the battery packs 300, an engine speed sensor 335 for measuring the revolutions per minute (RPM) of the engine 310, and a current gear sensor 340 for determining the gear of a vehicle transmission that is currently selected.

The controller 315 is configured to switch the alternator 305 between the operational or excited state and the non-operational or de-excited state based on the vehicle parameters determined using the vehicle sensors 320, 325, 330, 335 and 340. Specifically, in an embodiment, the controller 315 determines if the alternator 305 should be switched from the non-operational or de-excited state to the operational or excited state based on vehicle parameters including the accelerator pedal position, vehicle speed, engine speed, coolant temperature and total load on the battery packs. These vehicle parameters are determined by an accelerator pedal position sensor 320, a vehicle speed sensor 325, the engine speed sensor 335, a coolant temperature sensor and the load sensor 330. The controller 315 determines if the alternator 305 should be switched from the operational or excited state to the non-operational or de-excited state based on vehicle parameters including the accelerator pedal position, engine speed and current gear. These vehicle parameters are determined by the accelerator pedal position sensor 320, the engine speed sensor 335 and the current gear sensor 340.

An example of logic used by the controller 315 to switch the alternator 305 from the non-operational or de-excited state to the operational or excited state is shown in FIG. 4.

The controller 315 obtains the accelerator pedal position from the accelerator pedal position sensor 320. The controller then determines if the accelerator pedal position is less than an associated threshold amount, which in this example is 5% depressed. The controller 315 also obtains the vehicle speed from the vehicle speed sensor 325. The controller then determines if the vehicle speed is greater than an associated threshold amount, which in this example is 18 km/h. The controller 315 further obtains the engine speed from the engine speed sensor 335. The controller then determines if the engine speed is greater than an associated threshold amount, which in this example is 800 rpm. If the accelerator pedal position is less than the associated threshold amount and the vehicle speed and engine speed are greater than the associated threshold amounts then the controller 315 determines that a first alternator activation condition has been met. Otherwise, the controller 315 determines that the first alternator activation condition has not been met.

The first activation condition represents a determination of whether or not the engine is currently fuelling, i.e. operating to drive or provide traction or motive power to the vehicle. For example, the accelerator pedal being depressed for less than a threshold amount (e.g. 5%) may be indicative of the vehicle coasting. The inventors have also advantageously found that placing the alternator 305 into the operational or excited state when the vehicle speed is very low can result in undesirable short charging periods and rapid switching of the alternator 305 between the operational or excited state and the non-operational or de-excited state, particularly in passenger service vehicles that can often perform short accelerations and decelerations at low speeds between closely spaced stops in urban areas. However, since the determination of the vehicle speed being above threshold amounts before switching the alternator 305 into the operational or excited state, as described above, are built into the logic test for the first alternator activation condition such unwanted rapid switching can be advantageously avoided.

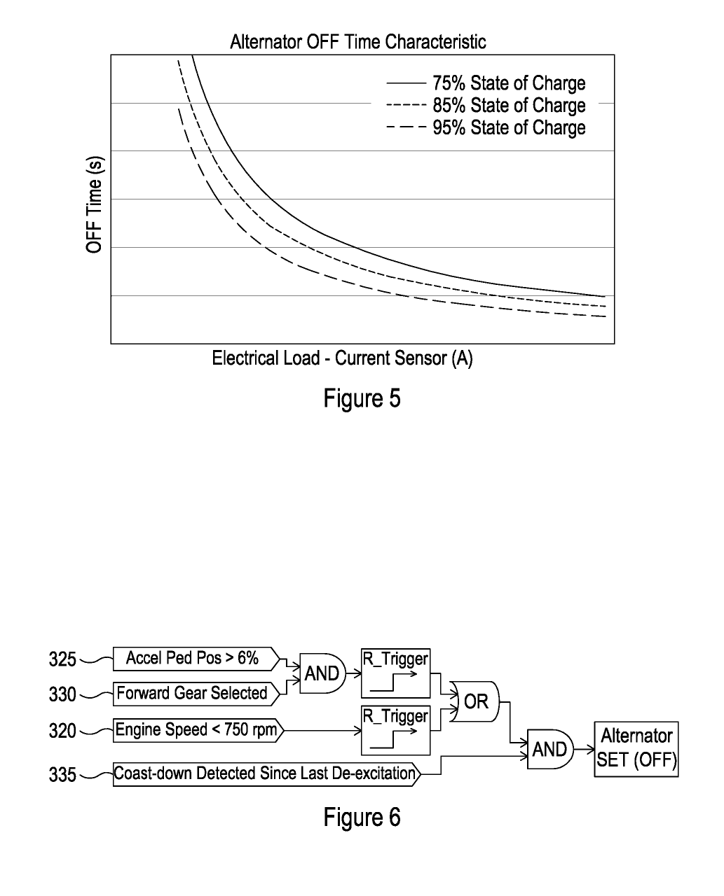

The controller 315 determines the load on the battery packs 300, i.e. the current being provided by the batteries whilst the alternator 305 is not in operation and/or is in the non-operational or de-excited state. The controller 315 is also pre-provided with or determines a target state of charge for the battery packs 300. For example, the target state of charge may be programmed into the controller 315 at manufacture or afterwards by a technician or driver or the like and may reflect the characteristics of the battery packs 300, the vehicle 100, 200, the route, the intended use of the vehicle and/or the like. In an optional example, the target state of charge may be determined using the methods, such as based on previous usage and/or routes, for example as outlined in GB1503167.7, which is in the name of the present applicant and the entire contents of which are hereby incorporated by reference. From the determined load on the battery packs 300 and the target state of charge, the controller 315 can determine an “off-time” that specifies a maximum period that the alternator 305 can be placed in the non-operational or de-excited state before being returned to the operational or excited state, for at least a period of time, e.g. using look-up tables, algorithms, graphs or other calibration data, for example, as shown in FIG. 5. The controller 315 is operable to determine if the alternator 305 has been in the non-operational or de-excited state for greater than the currently determined off-time and if so, the controller 315 determines that a second alternator activation condition has been met. Otherwise, the controller 315 determines that the second alternator activation condition has not been met.

By implementing a maximum “off time” in which the alternator 305 is in the non-operational or de-activated state, wherein the maximum off-time can be varied depending on load and target state of charge, the controller 315 can ensure that the battery packs 300 are used in a manner suitable for best battery performance. This may increase battery life and may minimise battery failure. For example, the above second alternator activation condition may ensure that at least a minimum state of charge is maintained and/or that the battery packs 300 are recharged within acceptable intervals.

The controller 315 is also configured to receive a measurement of the temperature of engine coolant from a coolant temperature sensor 345 and a measurement of the ambient temperature from an ambient temperature sensor (not shown). If the controller 315 determines that the temperature of the coolant is less than a threshold amount above ambient temperature (in this example less than ambient temperature plus 10° C.), then the controller determines that a third alternator activation condition has been met for a period of time, in this example for 10 minutes. The third activation condition allows the alternator 305 to be placed in the operational or active state for the period of time, e.g. 10 minutes, if it has been determined that the temperature of the engine coolant is less than a threshold amount above the ambient temperature.

This measure is reflective of a first use of the vehicle in a day. It may be particularly difficult to determine different days from use patterns of passenger service vehicles in particular, as they as often started and stopped and may return to depot several times in the course of their working day. The present inventors have found that measuring temperature of engine coolant relative to ambient temperature, for example as described above, may provide a suitable indication of a time interval in which regular charge of the battery packs 300 can be ensured.

Providing a charge or a full charge of the battery packs on a regular basis may improve the operational life of the battery packs 300. However, recharging the battery packs 300 too much may result in excessive operation of the alternator 305, with a resultant decrease in fuel efficiency of the engine 310. The inventors have found that forcing the alternator 305 into the operational or excited state on a regular period governed by the temperature of the engine coolant, particularly being less than a threshold amount above ambient, can be beneficially used as a measure of a suitable interval for forcing recharge of the battery packs 300, particularly in passenger service vehicles.

The controller 315 determines if any of the first, second or third alternator activation conditions has been met and if so, places the alternator 305 into the operational or excited state. Otherwise, the alternator remains in the non-operational or de-excited state.

An example of logic used by the controller 315 to switch the alternator 305 from the operational or excited state to the non-operational or de-excited state is shown in FIG. 6.

The controller 315 receives the accelerator pedal position from the accelerator pedal position sensor. The controller 315 determines if the accelerator pedal is depressed by more than an associated threshold amount, which is 6% depressed in the current example. The controller 315 also receives a current gear selection from the current gear selection sensor 340. The controller 315 determines if the currently selected gear is a forward gear. If the accelerator pedal has been depressed by over the relevant threshold amount and a forward gear has been selected, then the controller 315 determines that a first alternator deactivation condition has been met. When it is determined that the first alternator activation condition is met after having previously not been met, the controller 315 generates a rising trigger signal indicative thereof. This logic leading to the first alternator deactivation condition is indicative of the vehicle being accelerated, i.e. the engine is likely to be in a fuelling or demand condition and is being used to provide traction for the vehicle. In this case, preventing charging by the alternator 305 may result in increased fuel economy.

The controller 315 receives the engine speed from the engine speed sensor 335. The controller determines if the engine speed is less than an associated threshold amount, e.g. 750 rpm. If the engine speed is less than the associated threshold amount, then the controller determines that a second alternator deactivation condition has been met. Again, when it is determined that the second alternator activation condition is met after having previously not been met, the controller 315 generates a rising trigger signal indicative thereof.

The inventors have found that the engine 310 often draws significant amounts of fuel when idling below a certain engine speed threshold. In particular, the engine runs in an inefficient range when at idle engine speeds. Therefore, the inventors have identified that it is particularly beneficial to ensure there is no additional loading (i.e. from the alternator) under these conditions. Thus, by setting the alternator 305 into the non-operational or de-excited state if the engine speed is below an associated threshold, additional fuel consumption when the engine 310 is idle fuelling may be prevented or reduced. For example, in certain passenger service vehicles, idle fuelling can begin at a vehicle speed of approximately 13km/h or slower. However, this vehicle speed figure varies dependant on properties of the vehicle, such as which transmission is fitted. As such, use of the engine speed (e.g. an RPM<800 rpm) to determine when the idle fuelling begins can provide a more consistent and/or accurate indication of idle fuelling conditions across differing transmissions. Engine speed can also make a particularly suitable measure of idle fuelling, as it avoids unwanted hysteresis effects that may result from use of other parameters alone, such as vehicle speed.

The controller 315 determines if the alternator 305 has been placed in the operational or excited state since it was last placed in the non-operational or de-excited state. This check prevents the controller 315 from trying to put the alternator 305 into the non-operational or de-excited state for a second consecutive time without it having been placed in the operational or excited state (e.g. responsive to the logic shown in FIG. 4) in the intervening time. If the alternator 305 has been placed in the operational or excited state since it was last placed in the non-operational or de-excited state, then the controller 315 determines that a third alternator deactivation condition has been met.

If the controller 315 determines that the third alternator deactivation condition has been met and either of the first and/or second alternator deactivation conditions have also been met, then the controller 315 determines that the alternator 315 should be placed into the non-operational or de-excited state. However, the output from the above logic is first fed into a set/reset switch that provides an over-ride facility, whereby the alternator 315 can be forced into the operational or excited state by appropriate selection of the set/reset switch, over-riding the determination by the controller 315 that the conditions indicated in FIG. 6 for the non-operational or de-excited state have been met. However, if the set/reset switch has not been set to over-ride then the controller 315 places the alternator 315 into the non-operational or de-excited state. If the controller 315 determines that the third alternator deactivation condition has not been met and/or that both of the first and second alternator deactivation conditions have not been met, then the controller 315 maintains the alternator 315 in its existing state.

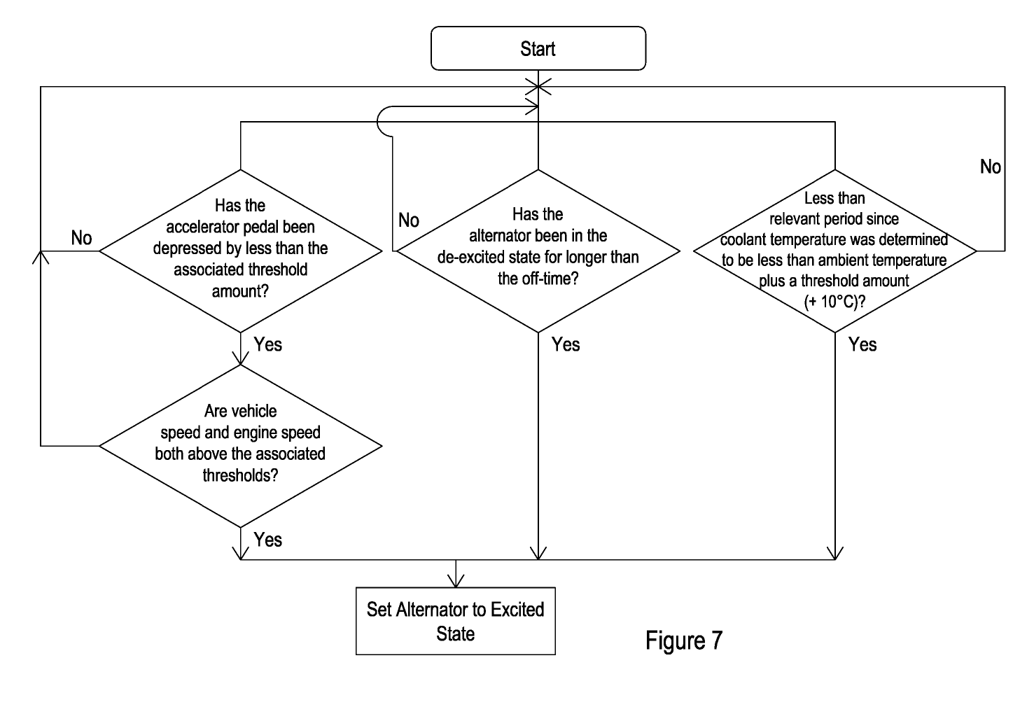

FIG. 7 illustrates a method that implements the logic for switching the alternator 305 from the non-operational or de-excited state to the operational or excited state as shown in FIG. 4. In particular, if it is determined that (1) the accelerator pedal has been depressed by less than the associated threshold amount (e.g. by less than 5%) and the vehicle speed and engine speed are above the associated thresholds (e.g. above 18 km/h and 800 rpm respectively); or (2) the alternator 305 has been in the non-operational or de-excited state for longer than the off-time that has been determined based on the load on the battery when not being charged and the target state of charge; or (3) it has been less that the relevant period (e.g. 10 minutes) since the determination has been made that the coolant temperature is below a temperature that is the ambient temperature plus the threshold amount, then the alternator 305 is switched into the operational or excited state. Otherwise, the alternator 305 is maintained in its existing state (e.g. the non-operational or de-excited state).

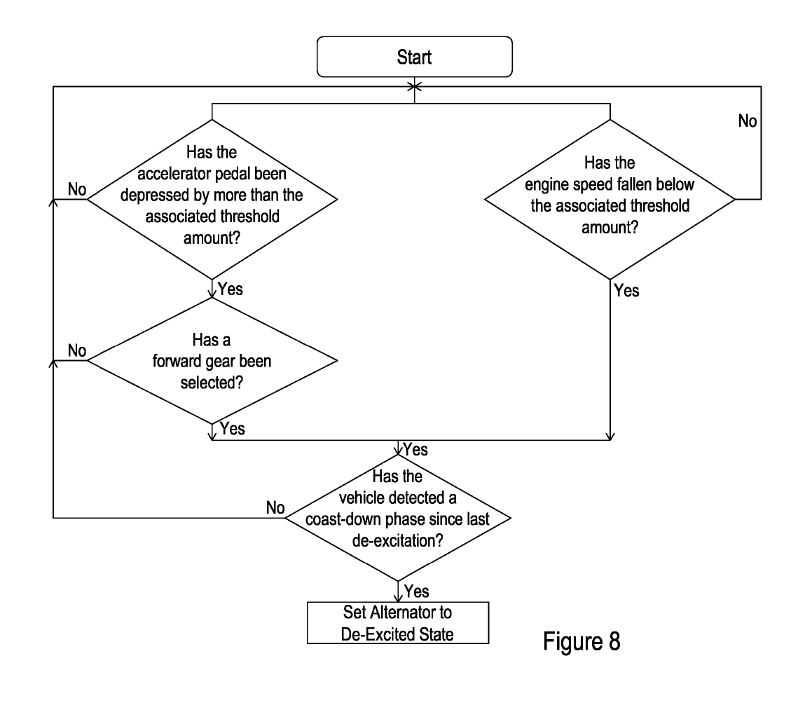

FIG. 8 illustrates a method that implements the logic for switching the alternator 305 from the operational or excited state to the non-operational or de-excited state as shown in FIG. 6. In particular, if it is determined that (i) the alternator 305 has been switched into the operational or excited state (e.g. using the method of FIG. 7 and/or the logic of FIG. 4) since last being switched into the non-operational or de-excited state; and either (ii) the engine speed is less than the associated threshold amount (e.g. less than 750 rpm); or (iii) the accelerator pedal has been depressed by more than the associated threshold amount (e.g. by more than 6% of its range) and a forward gear has been selected, then the alternator 305 is switched into the non-operational or de-excited state, subject to operation of an over-ride set/unset switch. Otherwise, the alternator 305 is left in its existing state.

Optionally, the controller 315 can be configured to vary the voltage supplied by the alternator 305 to the battery packs 300. In particular, when the state of charge of the battery packs 300 is low, then the battery packs 300 can stand higher charging voltages without overheating. Higher charging voltages allow for faster charging of the battery packs 300 and thereby further potential fuel savings. However, if the higher charging voltages are applied when the state of charge of the battery packs 300 is too high, then there is a risk that the battery packs 300 will overheat. In order to reduce the charging time and increase the fuel savings, the controller 315 is operable to increase the charging voltage provided from the alternator 305 to the battery packs 300 when the state-of-charge of the battery packs 300 is low enough to safely receive the higher charging voltage and decrease the charging voltage once the state-of-charge of the batter packs 300 has increased.

In a particular example of an application of this principle, a measurement of the current flowing from the alternator 305 into the battery packs 300 whilst the battery packs 300 are being charged is used as an indicator of state-of-charge of the battery packs (the charging current and the state-of-charge are generally inversely related, such that when the charging current is high, the state-of-charge is low and vice-versa). However, it will be appreciated that other indicators of the state-of-charge of the battery packs 300 could be used instead.

In examples, if the battery charging current is above a predetermined threshold, then the voltage provided to the battery packs 300 from the alternator 305 is switched to a higher voltage level. This ensures faster charging and increased fuel savings in situations when this can be safely used. To ensure safety and prevent overheating, the controller 315 is configured to reduce the voltage provided to the battery packs 300 from the alternator 305 to a lower voltage level, e.g. when the battery charging current drops below a predetermined threshold and/or after a predetermined period of time.

Although specific examples have been described above in relation to the drawings, the skilled person will be able to envisage other embodiments without departing from the scope of the appended claims.

For example, although the alternator 305 is described as being coupled to the engine 310 via a drive belt or being coupled to the crankshaft via a gearing arrangement, it will be appreciated that other arrangements of directly or indirectly coupling the alternator 305 to the engine 310 could be provided.

In addition, although a technique for placing the alternator 305 in the non-operational or de-excited state by earthing the coiled windings of the alternator 305 is described, it will be appreciated that other types or arrangements of alternator or charging apparatus and/or other techniques for placing the alternator or charging apparatus in the non-operation or de-excited state may be used.

Furthermore, although an example of a relationship between the off-time period and load on the battery packs 300 whilst not being charged and target state of charge is presented in FIG. 5, it will be appreciated that other determinations of the off-time period may be used, which may be based on other relationships between load on the battery packs and/or load being drawn by one or more or each component of the vehicle's electrical system and/or state of charge or target state of charge may be used.

Additionally, whilst the present invention has been described in relation to some examples of particularly suitable passenger service vehicles as shown in FIGS. 1 and 2, it will be appreciated that the present invention may also be beneficially applied to other vehicles, such as boats, heavy duty vehicles including trucks, or the like (but being particularly suited to passenger service vehicles).

Furthermore, although determinations of whether or not the alternator 305 should be switched between the operational or excited state and the non-operational or de-excited state based on certain vehicle parameters are described above, it will be appreciated that different combinations of vehicle parameters or more or less of the parameters given above may be used in these determinations. Furthermore, although various specific examples of suitable thresholds are given above, it will be appreciated that these thresholds may vary depending on the vehicle, the battery packs, alternator, the required operational conditions or route and/or the like.

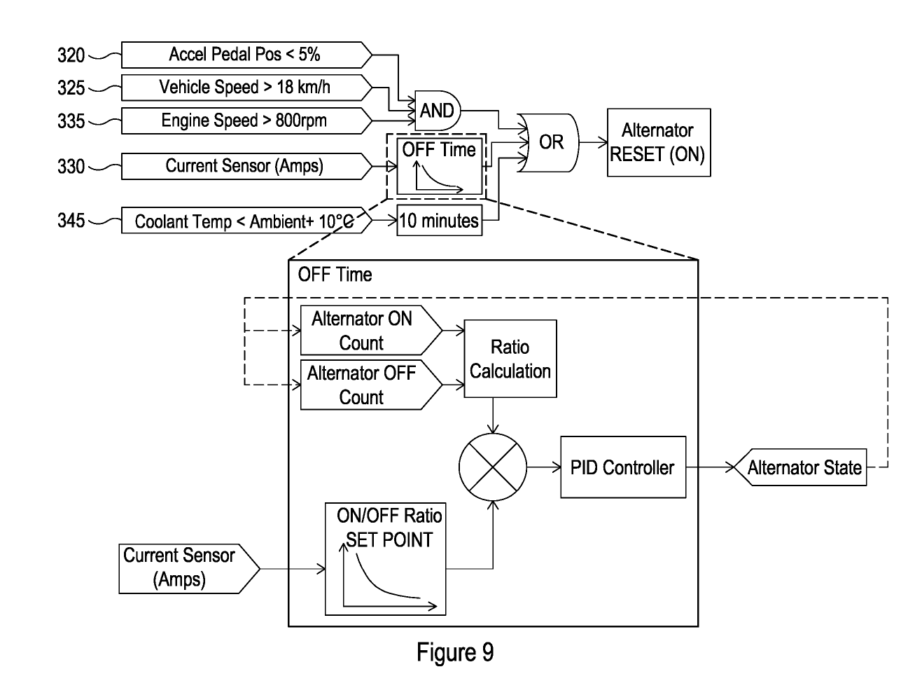

In addition, although in certain embodiments described above, the alternator 305 is switchable into the non-operational or de-excited state for a certain period of time, it will be appreciated that this need not be the case. For example, FIG. 9 shows a variation of the logic shown in FIG. 4. In this case, as in the above embodiments, the controller 315 is in communication with various vehicle sensors for measuring a plurality of vehicle parameters, such as an accelerator pedal position sensor 320, a vehicle speed sensor 325, a load sensor 330 for measuring total current being drawn from the battery packs 300, an engine speed sensor 335 for measuring the revolutions per minute (RPM) of the engine 310, and a coolant temperature sensor 345 for measuring the temperature of engine coolant. The embodiment of FIG. 9 generally works in the manner described above in relation to FIG. 4. However, in the embodiment of FIG. 4, using the determined load on the battery packs 300 from the load sensor 330 and the target state of charge, the controller 315 determines an “off-time” that specifies a maximum period that the alternator 305 can be placed in the non-operational or de-excited state before being returned to the operational or excited state. In contrast, in the embodiment of FIG. 9, instead of the simple “off-time” characteristic, the embodiment of FIG. 9 uses an on/off ratio, which is dependent on the current flow from the battery packs 300 when the alternator 305 is switched off. In this case, rather than count an “off time” as a determined period, as in FIG. 4, the controller 315 counts the time for which the alternator 305 is in an on-state (e.g. in the operational or excited state) and the time for which the alternator 305 is in an off state (e.g. in the non-operational or de-excited state) and calculates the on/off ratio as a ratio of the time in which the alternator 305 is in each state. The controller 315 then automatically controls the time that the alternator 305 is in the non-operational or de-excited state (i.e. the “off time”) dependent on a difference between the actual on/off time ratio and a target on/off ratio that is set dependent on the current flow from the battery packs 300.

In particular, the controller 315 is provided with or configured to access predetermined correspondence data such as a look-up table or algorithm that associates various values of target on/off ratio to corresponding values or ranges of current flow from the battery packs 300. In this way, the measured current flow from the battery packs 300 can be cross referenced against the correspondence data in order to determine the applicable target on/off ratio. As such, the controller 315 can control / vary the time that the alternator 305 is in the non-operation or de-excited state (i.e. the “off state”) in order to achieve the target on/off ratio.

In this way, the state of charge of the battery packs 300 is maintained by the on/off ratio rather than a determined “off time”, as is the case in the embodiment of

FIG. 4. The situation in FIG. 4 that controls according to an “off time” is akin to open loop control, whereas the embodiment of FIG. 9 that uses a variable “on/off ratio” that seeks to meet a target on/off time ratio that is set, in use, dependent on the discharge current from the battery packs 300 is more akin to closed loop control. The embodiment of FIG. 9 effectively self-adjusts on all drive cycles or journeys (not just certain drive cycles or journeys), enabling more accurate state-of-charge control of the battery packs 300, which in turn improves the potential for fuel savings.

As such, the scope of the present invention is defined by the scope of the claims appended herewith and is not limited to any specific features described above in relation to the drawings.

1. A controller or processing system for a vehicle, such as a passenger service vehicle, the vehicle comprising at least one energy storage system, and at least one alternator or other charging device coupled to and/or operable or driven by an engine or motor, wherein the alternator or other charging device is switchable between an operational state and a non-operational state by the controller or processing system responsive to one or more parameters of the vehicle.

2. The controller or processing system of claim 1, wherein, in the operational state, the alternator or other charging device is configured to provide electrical charge to the at least one energy storage system when operated or driven by the engine or motor and, in the non-operational state, the alternator or other charging device does not provide electrical charge to the at least one energy storage system even when the engine or motor is operating.

3. The controller or processing system of claim 1, configured to implement criteria or logic, specifying one or more ranges, values or criteria of the at least one or more or each of the parameters of the vehicle to be met to switch the alternator or other charging device from the operational state to the non-operational state and/or to switch the alternator or other charging device from the non-operational state to the operational state.

4. The controller or processing system according to claim 1, wherein the one or more parameters of the vehicle comprise one or more or each of: acceleration of the vehicle, accelerator pedal position, vehicle speed, rotation speed of the engine, the gear currently selected, the current being drawn from, or load on, the at least one energy storage system and/or current being drawn by one or more or all electrical components of the vehicle and/or engine coolant temperature.

5. The controller or processing system of claim 1, configured to switch the alternator or other charging device into the non-operational state when the engine or motor is fuelling and/or providing traction or motive power to the vehicle or the vehicle is accelerating, maintaining speed and/or not coasting.

6. The controller or processing system of claim 1, configured to switch the alternator or other charging device into the operational state when the vehicle is coasting, decelerating and/or the engine or motor is not fuelling and/or not providing traction or motive power to the vehicle.

7. The controller or processing system of claim 1, configured to determine if the accelerator pedal is not depressed or depressed by more or less than an accelerator threshold amount and at least partially determine whether or not to switch the alternator or other charging device between the operational state and the non-operational state dependent on whether the accelerator pedal has been depressed by more or less than the accelerator threshold amount or not depressed.

8. The controller or processing system of claim 1, configured to determine if the vehicle speed is greater than a speed threshold amount and switch the alternator or other charging device into the operational state based at least partially on the determination that the vehicle speed is greater than the speed threshold amount.

9. The controller or processing system of claim 1, configured to determine if the engine speed is more or less than an engine speed threshold amount and at least partially determine whether or not to switch the alternator or other charging device between the operational state and the non-operational state dependent on whether the engine speed is more or less than the engine speed threshold amount.

10. The controller or processing system of claim 1, configured to determine a gear in which a transmission of the vehicle is currently in or is using and switch the alternator or other charging device to the non-operational state based at least partially on the gear being determined to be a forward gear.

11. The controller or processing system of claim 3, configured to switch the alternator or other charging device into the non-operational state for a determined or predetermined period of time or off-time when one or more or each of the ranges, values or criteria of the at least one or more or each of the parameters of the vehicle for switching the alternator or other charging device into the non-operational state are met.

12. The controller or processing system of claim 11, wherein the controller or processing system is configured to determine and/or vary the period of time based on a calculated, determined or expected load on the at least one energy storage system and/or based on a current being drawn from the at least one energy storage system or being drawn by the vehicle's electrical systems and/or based on state of charge or target state of charge of the at least one energy storage system.

13. The controller or processing system according to claim 12, configured to:
reduce the period of time with increasing load on the at least one energy storage system and/or with increasing current drawn from the at least one energy storage system or by the vehicle's electrical systems and/or with increasing target state of charge of the at least one energy storage system; and/or
increase the period of time with decreasing load on the at least one energy storage system and/or with decreasing current drawn from the at least one energy storage system or by the vehicle's electrical systems and/or with decreasing target state of charge of the at least one energy storage system.

14. The controller or processing system of claim 1, configured to switch or ensure the alternator is in the operational state and/or charge or continuously charge the at least one energy storage system for at least a predetermined or determined period at predetermined or determined intervals.

15. The controller or processing system of claim 14, configured to determine when or if the temperature of engine coolant is less than a temperature equal to ambient temperature plus a threshold amount and switch the alternator or other charging device into the operational state for at least the predetermined or determined period when or if the temperature of the engine coolant is less than the temperature that is equal to ambient temperature plus the threshold amount.

16. The controller or processing system of claim 1, configured to check that the alternator is in the operational state, or has been switched into the operational state since the last determination that the alternator should be placed in the non-operational state, before switching the alternator into the non-operational state, or vice versa.

17. The controller or processing system of claim 1, wherein the alternator or other charging device comprises a coil or wiring in which flow of electrical current is induced during operation of the alternator or other charging device and the controller or processing system is configured to:
switch the coil or wiring into a connected state in which it is electrically connected to the at least one energy storage system in order to switch the alternator or other charging device into the operational configuration; and/or
switch the coil or wiring into a disconnected or grounded or earthed state in order to switch the alternator or other charging device into the non-operational configuration.

18. An electrical system for a vehicle, such as a passenger service vehicle, the electrical system comprising at least one energy storage system, at least one alternator or other charging device and a controller or processing system according to claim 1, wherein the controller or processing system is configured to switch the alternator or other charging device between an operational state and a non-operational state responsive to one or more parameters of the vehicle.

19. A vehicle, such as a passenger service vehicle, the vehicle comprising the controller or processing system of claim 1, at least one energy storage system, and at least one alternator or other charging device coupled to and/or operable by or driven by an engine or motor; wherein the controller or processing system is configured to switch the alternator or other charging device between an operational state and a non-operational state responsive to one or more parameters of the vehicle.

20. A method of producing a controller or processing system according to claim 1, the method comprising:
providing a controller or processing system comprising a processing unit, a memory and a communications system;
configuring or programming the controller or processing system to control operation of an alternator or other charging device by switching the alternator or other charging device between an operational state and a non-operational state responsive to one or more parameters of the vehicle.

21. A method of controlling an alternator or other charging device, the method comprising controlling operation of the alternator or other charging device by switching the alternator or other charging device between an operational state and a non-operational state responsive to one or more parameters of the vehicle.

22. The method of claim 21, wherein the one or more parameters of the vehicle comprises one or more or each of: acceleration of the vehicle, accelerator pedal position, vehicle speed, rotation speed of the engine, the gear currently selected and/or the current being drawn from, or load on, the at least one energy storage system and/or current being drawn by one or more or all electrical components of the vehicle and/or engine coolant temperature relative to ambient temperature.

23-26. (canceled)
